(19) United States
(12) Patent Application Publication
(10) Pub. No.: US 2005/0129482 A1
(43) Pub. Date: Jun. 16, 2005

(54) Retention device

(76) Inventor: San S. Wang, Liu City (TW)

Correspondence Address: MARGER JOHNSON & McCOLLOM, P.C., 1030 S.W. Morrison Street, Portland, OR, 97205-2626, US

(21) Appl. No.: 10/738,697

(22) Filed: Dec. 16, 2003

(51) Int. Cl. F16B 21/00

(52) U.S. Cl. 411/340

(57) ABSTRACT

A retention device includes a one-piece longitudinal anchor member having opposed first and second ends, a nut retaining part formed between the first and second ends, a through hole extending through the nut retaining part, and an engagement surface around the through hole. A screw rod extends through the through hole and engages threadedly a nut, and is turnable between folded and unfolded positions, in which the screw rod is moved toward and away from the first end, respectively. The nut is movable within the through hole between engaging and non-engaging positions. The nut engages and disengages the engagement surface in the engaging and non-engagement positions when the screw rod is in the unfolded and folded positions, respectively.

### BACKGROUND OF THE INVENTION

1. Field of the Invention

The invention relates to a retention device, more particularly to a retention device for a hook.

2. Description of the Related Art

Referring to FIGS. 1 and 2, a conventional hook retention device 1 is applicable on a wall surface or a ceiling 2 (see FIGS. 3 and 4), and includes two anchor plates 11, 12, a torsion spring 13, a nut 14, and a screw rod 15.

Each of the anchor plates 11, 12 is generally U-shaped, and has a main wall 111, 121, two opposite side walls 113, 123 that extend downwardly and respectively from two side edges of the main wall 111, 121 and that cooperate with the main wall 111, 121 to define a receiving space 112, 122, a pair of aligning holes 114, 224 formed in inner ends of the side walls 113, 123, and a groove 115, 125 formed in an inner end of the main wall 111, 121. The grooves 115, 125 in the main walls 111, 121 of the anchor plates 11, 12 cooperate to form a circular hole 10 (see FIG. 2) for extension of the screw rod 15 therethrough.

The nut 14 has a main body 141, a central screw hole 142 for threaded engagement with the screw rod 15, and two opposite extension parts 143 that extend outwardly from an outer periphery of the main body 141 and that extend respectively into the pair of aligning holes 114, 224 in the anchor plates 11, 12.

The torsion spring 13 has a body portion 131 sleeved on one of the extending parts 143 of the nut 14, and two opposite supporting portions 132 that extend outwardly from the body portion 131 into a respective one of the receiving spaces 112, 122 and that abut against a respective one of the main walls 111, 121.

The screw rod 15 has a head portion 151 larger than that of the circular hole 10, and a threaded shank portion 152 extending outwardly from the head portion 151. The threaded shank portion 152 extends through the circular hole 10 and further through the screw hole 142 in the nut 14 so as to engage threadedly a screw hole 161 (see FIGS. 2 and 3) in a hook 16 so that the screw rod 15 and the hook 16 form an intergral body.

Referring to FIGS. 3 and 4, to assemble the hook retention device 1 on the ceiling 2, the user initially uses his two fingers to press the anchor plates 11, 12 toward each other against the elastic force of the torsion spring 13, after which the hook retention device 1 is inserted into a through hole 21 in the ceiling 2. Upon passing the anchor plates 11, 12 through the through hole 21, the torsion spring 13 pushes the anchor plates 11, 12 apart so that the latter cannot be removed from the ceiling 2. Then, the hook 16 is pulled downwardly, as shown by the arrow (I) in FIG. 4, so that bottom portions of the side walls 113, 223 of the anchor plates 11, 12 abut against the ceiling 2. Afterwards, the hook 16 is rotated and tightened, as shown by the arrow (II) in FIG. 4, so as to move upwardly the screw rod 15 relative to the nut 14 until the hook 16 abuts against the ceiling 2 and is fixed on the same. An object (not shown) can be hung on the hook 16 at this time.

Although the aforementioned conventional hook retention device 1 can achieve its intended purpose, it has the following disadvantages:

1. When the hook 16 is rotated for tightening, the side walls 113, 123 of the anchor plates 11, 12 abut against the ceiling 2. Since friction between the side walls 113, 123 and the ceiling 2 is small, the anchor plates 11, 12 are likely to rotate idly along with the hook 16, thereby resulting in inconveniences during assembly of the conventional hook retention device 1.

2. When the hook 16 bears a heavy load, it is easily damaged because only the nut 14, which is a thin plate, serves as a load bearing point for the whole load, thereby resulting in a shorten service life for the hook retention device 1.

3. Since the lengths of the anchor plates 11, 12 are limited, when they are to be inserted into the through hole 21 in the ceiling 2, it is difficult for the fingers of the user to grasp effectively the anchor plates 11, 12 so that the anchor plates 11, 12 tend to be stretched slightly and outwardly by the torsion spring 13. Due to the outwardly stretched anchor plates 11, 12, the through hole 21 has to be enlarged so as to facilitate installation. However, the resulting outer appearance is unappealing.

### SUMMARY OF THE INVENTION

Therefore, the object of the present invention is to provide a retention device that is simple and easy to assemble, that can support a heavy load, and that has an appealing appearance.

According to this invention, a retention device comprises a one-piece longitudinal anchor member, a nut, and a screw rod. The anchor member has longitudinally opposed first and second ends, a nut retaining part formed between the first and second ends, a through hole extending through the nut retaining part transversely of the anchor member, and an engagement surface around the through hole. The nut is movably received within the through hole. The screw rod extends through the through hole, and engages threadedly the nut. The screw rod is turnable between a folded position and an unfolded position. In the folded position, the screw rod is moved toward the first end. In the unfolded position, the screw rod is moved away from the first end. The nut is movable within the through hole between an engaging position and a non-engaging position. The nut engages the engagement surface in the engaging position when the screw rod is in the unfolded position. The nut is in the non-engaging position when the screw rod is in the folded position.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional hook retention device;

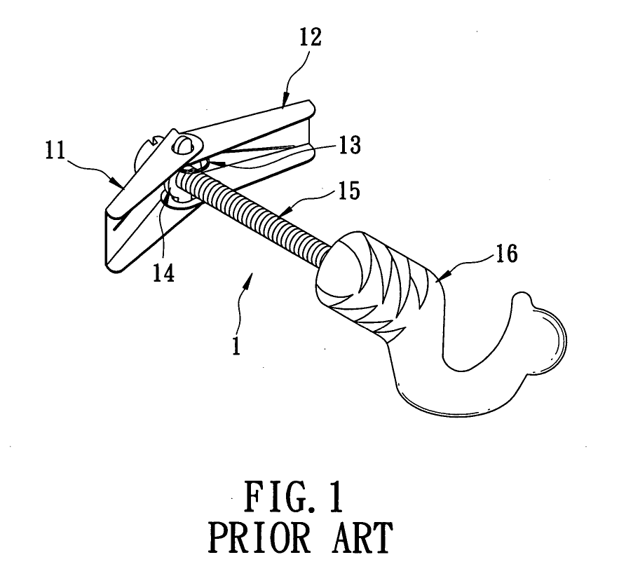

FIG. 2 is an exploded perspective view of the conventional hook retention device;

FIG. 3 illustrates how the conventional hook retention device is installed on a ceiling;

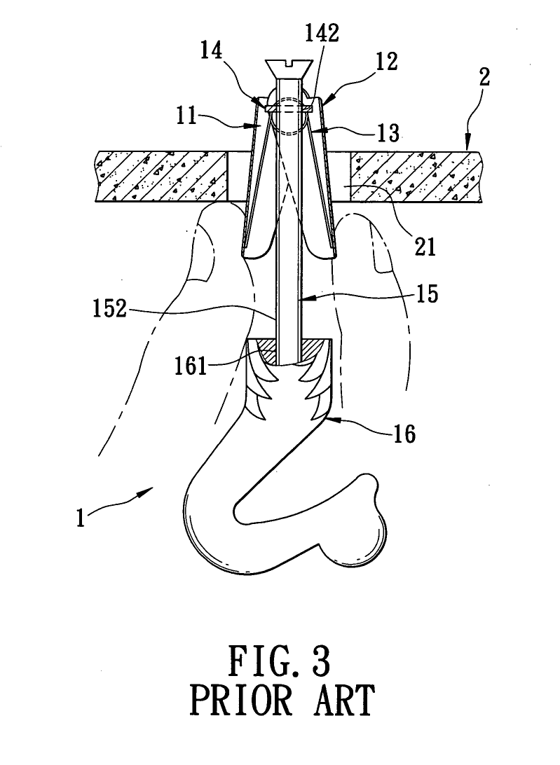

FIG. 4 illustrates how the conventional hook retention device is retained on the ceiling;

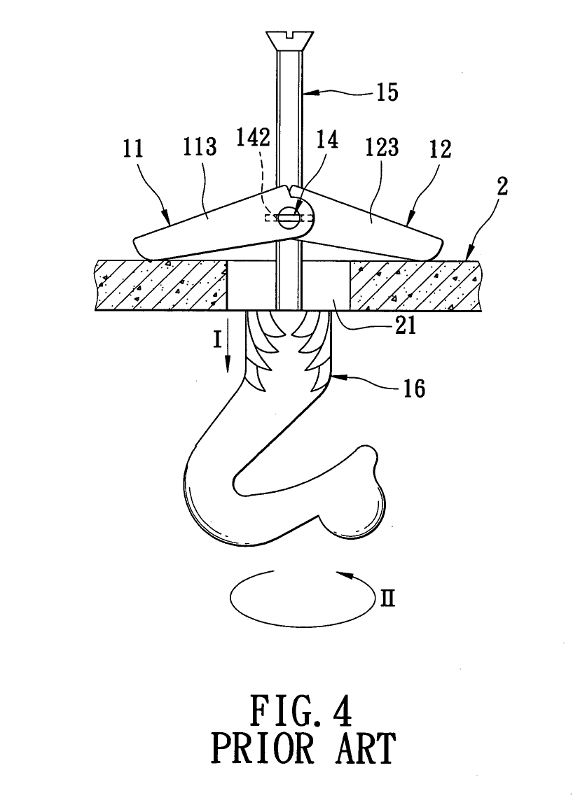

FIG. 5 is an exploded perspective view of the first preferred embodiment of a retention device according to the present invention;

FIG. 6 is a perspective view of an anchor member of the first preferred embodiment;

FIG. 7 is an assembled schematic partly sectional view of the first preferred embodiment, illustrating a folded position of a screw rod;

FIG. 8 is an assembled schematic partly sectional view of the first preferred embodiment, illustrating an unfolded position of the screw rod;

FIG. 9 is an exploded perspective view of the second preferred embodiment of the retention device according to the present invention;

FIG. 10 is an assembled schematic partly sectional view of the second preferred embodiment, illustrating a folded position of a screw rod; and

FIG. 11 is an assembled schematic partly sectional view of the second preferred embodiment, illustrating how a resilient element biases the screw rod away from the anchor member.

### DETAILED DESCRIPTION OF THE PREFERRED EMBODIMENTS

Before the present invention is described in greater detail, it should be noted that like elements are denoted by the same reference numerals throughout the disclosure.

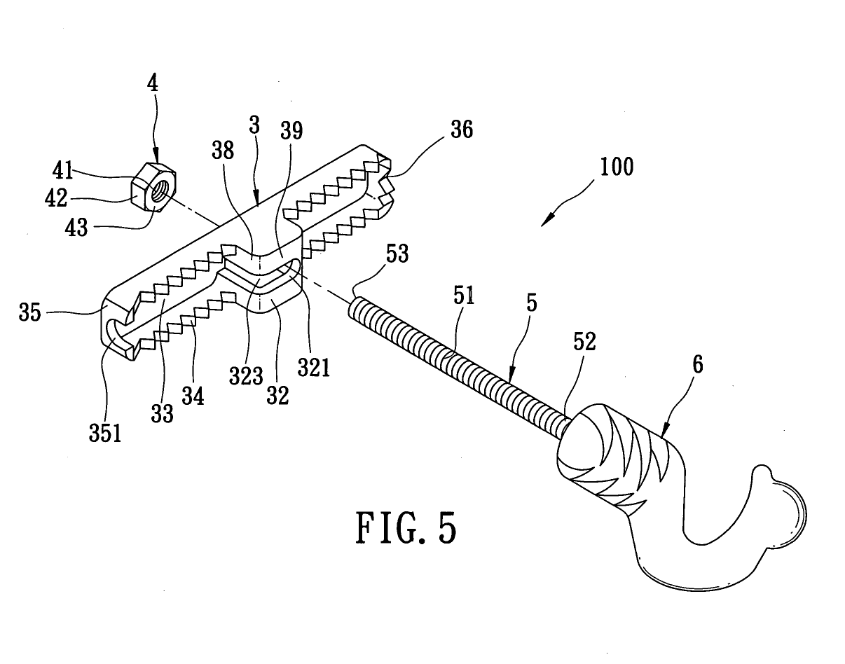

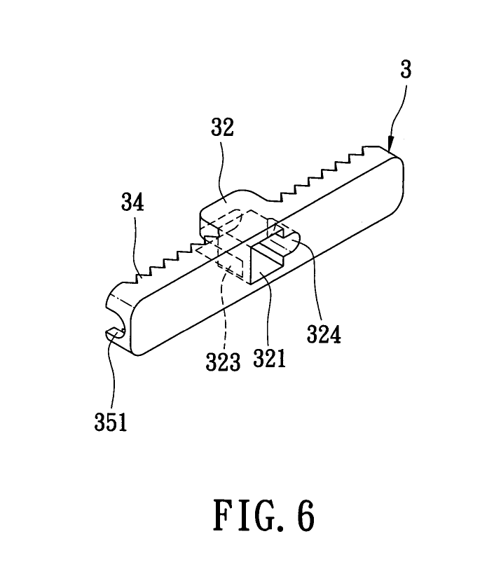

Referring to FIGS. 5 and 6, the first preferred embodiment of a retention device 100 according to the present invention is shown to comprise a one-piece longitudinal anchor member 3, a nut 4, and a screw rod 5. The retention device 100 further has a hook 6 provided at one end of the screw rod 5.

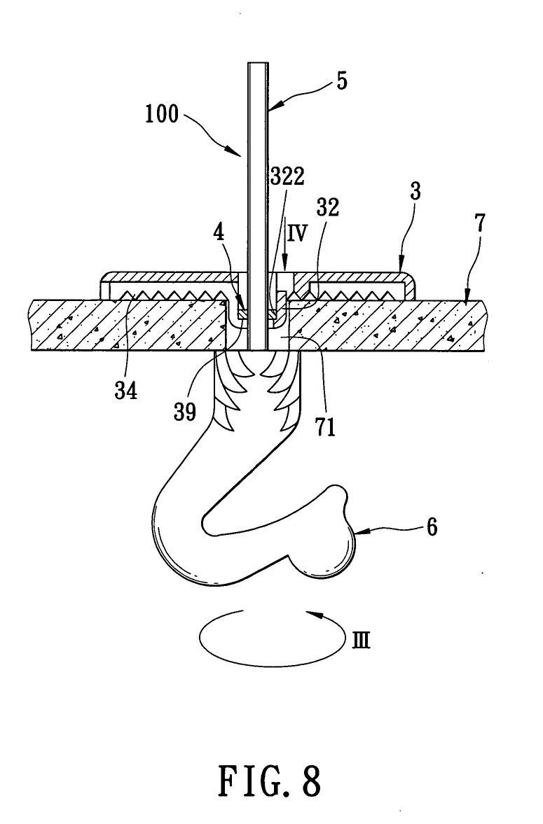

The anchor member 3 has longitudinally opposed first and second ends 35, 36, a nut retaining part 32 formed between the first and second ends 35, 36, an anchoring surface 34 extending from the first end 35 to the second end 36, and a receiving space 33 formed in the anchoring surface 34. The first end 35 is formed with a notch 351 that is in spatial communication with the receiving space 33. The nut retaining part 32 protrudes outwardly from the anchoring surface 34 in a direction transverse to the anchor member 3, and is formed with a through hole 321 extending through the nut retaining part 32 transversely of the anchor member 3, and an engagement surface 322 (see FIG. 8) around the through hole 321. The anchoring surface 34 is toothed for effective engagement with a support to which the retention device 100 will be attached. A slot 324 is formed in the nut retaining part 32 at a side opposite to the anchoring surface 34, and is in spatial communication with the through hole 321.

The nut retaining part 32 has a multi-sided lateral wall 38 extending outwardly from the anchoring surface 34, and an end wall 39 connected transversely to the lateral wall 38. The lateral wall 38 is four-sided in this embodiment, and cooperates with the end wall 39 to confine the through hole 321. The through hole 321 extends through the end wall 39. The engagement surface 322 is formed on an inner side of the lateral wall 38 proximate to the end wall 39. The nut retaining part 32 further includes an L-shaped aperture 323 which is in spatial communication with the through hole 321 and which extends from the end wall 39 to the lateral wall 38.

The nut 4, in this embodiment, is a hexagonal nut having a central screw hole 41, and has a size smaller than the size of the through hole 321 so that the nut 4 is movable within the through hole 321 between an engaging position and an on-engaging position. However, the nut 4 should not be rotatable when in the engaging position. Accordingly, the nut 4 has an axially extending peripheral face 42, and a radial face 43 connected to the peripheral face 42. When the nut 4 is in the engaging position, the radial face 43 abuts against the end wall 39, and the peripheral face 42 engages the engagement surface 322. When the nut 4 is in the non-engaging position, the radial face 43 confronts the lateral wall 38.

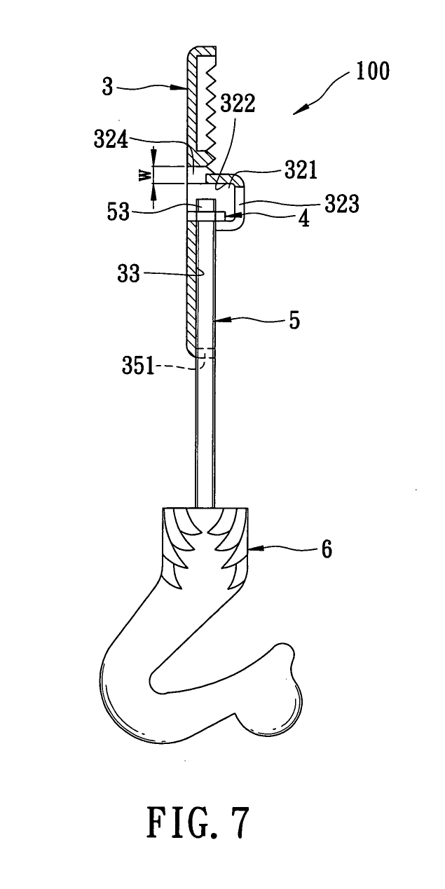

The screw rod 5 has a threaded shank portion 51, which has one end 52 secured to the hook 6, and an opposite end 53 that extends through the aperture 323 and the through hole 321 and that engages threadedly the nut 4 through the screw hole 41. The screw rod 5 is turnable along the aperture 323 between a folded position (see FIG. 7) and an unfolded position (see FIG. 8). In the folded position, the screw rod 5 is substantially parallel to the anchor member 3, and is located at the vicinity of the first end 35. In the unfolded position, the screw rod 5 is substantially perpendicular to the anchor member 3, and is located away from the first end 35. The screw rod 5 is received in and engages releasably the notch 351 when the former is in the folded position.

Referring to FIGS. 7 and 8, during assembly, after the end 53 of the screw rod 5 is passed through the aperture 323 and the through hole 321 in the nut retaining part 32 and engages threadedly the nut 4, the screw rod 5 is pulled downwardly so that the nut 4 is received in the through hole 321. Then, the screw rod 5 is turned along the aperture 323 so as to be retained in the receiving space 33 and the notch 351. At this time, the screw rod 5 is disposed at the folded position, and the nut 4 is in the non-engaging position. Note that the end 53 of the screw rod 5 which projects out of the through hole 321 should have a length smaller than the width (w) of the slot 324 so that the end 53 can turn into the through hole 321 through the slot 324 when the screw rod 5 is turned within the aperture 323.

Thereafter, the screw rod 5 is inserted into a passage 71 in the ceiling 7 until the anchor member 3 passes through the passage 71. When a slight external force is applied to move to and fro the screw rod 5, through the weight of the anchor member 3, the anchor member 3 moves away from the screw rod 5. When the screw rod 5 is pulled downwardly relative to the ceiling 7, the anchoring surface 34 of the anchor member 3 engages a top side of the ceiling 7, and the nut 4 engages the engagement surface 322. The screw rod 5 is disposed in the unfolded position at this time, and the nut 4 is in the engaging position where it engages the engagement surface 322 of the nut retaining part 32. Finally, the hook 6 is grasped and rotated, as shown by the arrow (III) in FIG. 8, so as to rotate the screw rod 5 simultaneously. Because the anchor member 3 is already positioned on the top surface of the ceiling 7, the nut 4 moves downwardly and threadedly along the through hole 321 relative to the screw rod 5, as shown by the arrow (IV) in FIG. 8, without idly rotating with the screw rod 5. An upper face of the hook 6 abuts against a bottom side of the ceiling 7 at this time so that the anchoring surface 34 of the anchor member 3 presses tightly against the top side of the ceiling 7, thereby retaining stably the retention device 100 of the present invention on the ceiling 7.

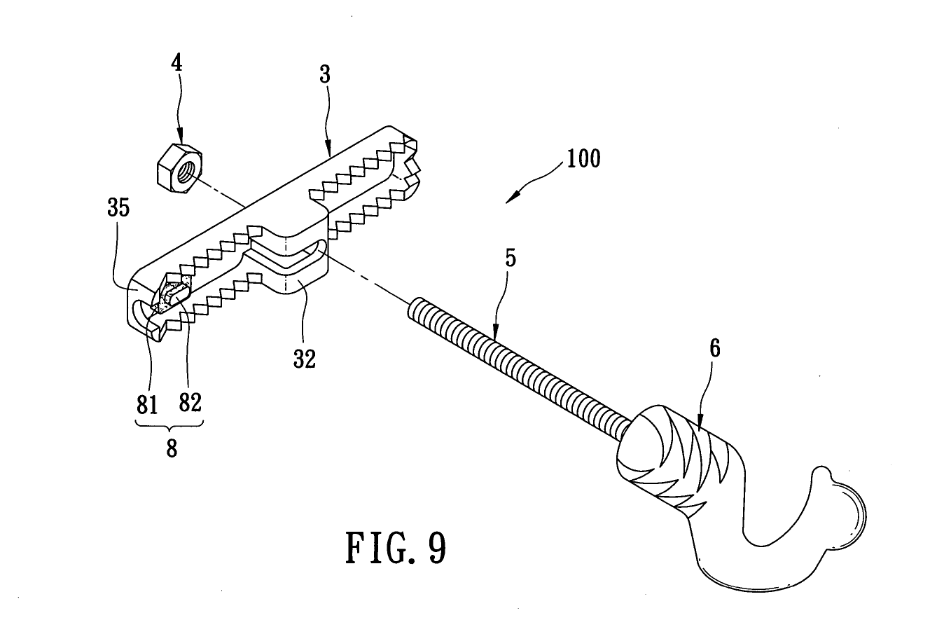

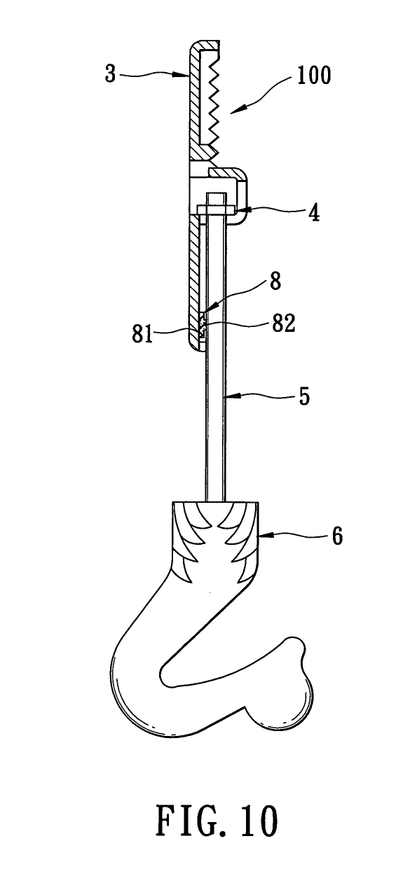

Referring to FIGS. 9 and 10, the second preferred embodiment of the retention device 100 according to the present invention is shown to be substantially similar to the first preferred embodiment. However, in this embodiment, the retention device 100 further includes a resilient element 8 disposed on the anchor member 3 between the nut retaining part 32 and the first end 35. The resilient element 8 is made of a rubber material, and has a base body 81 adhered to the anchor member 3 proximate to the first end 35, and a resilient part 82 that projects outwardly from the base body 81 and that has a dimension smaller than that of the base body 81.

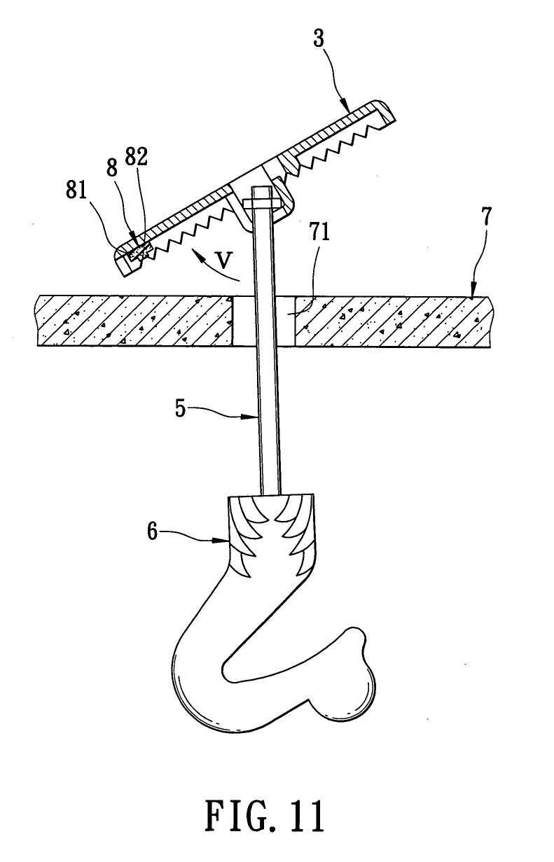

When the screw rod 5 is turned to the folded position, as shown in FIG. 10, it presses against the resilient element 8 so that the base body 81 and the resilient part 82 are in a compressed state. Then, the screw rod 5 is inserted into the passage 71 in the ceiling 7 until the anchor member 3 extends completely through the passage 71. When an external force is applied to move to and fro the screw rod 5, the screw rod 5 is released from the notch 351. Simultaneously, the resilient element 8 springs back, and the anchor member 3 moves away from the screw rod 5, as shown by the arrow (V) in FIG. 11. The screw rod 5 is now at the unfolded position.

The advantages of the retention device 100 of the present invention can be summarized as follows:

1. Because the anchor member 3 is positioned on the top side of the ceiling 7, and because the anchoring surface 34 of the anchor member 3 engages the top side of the ceiling 7, the anchor member 3 will not rotate idly and simultaneously with the hook 6 when the hook 6 is rotated to move upwardly. Therefore, installation of the present invention is relatively simple and stable.

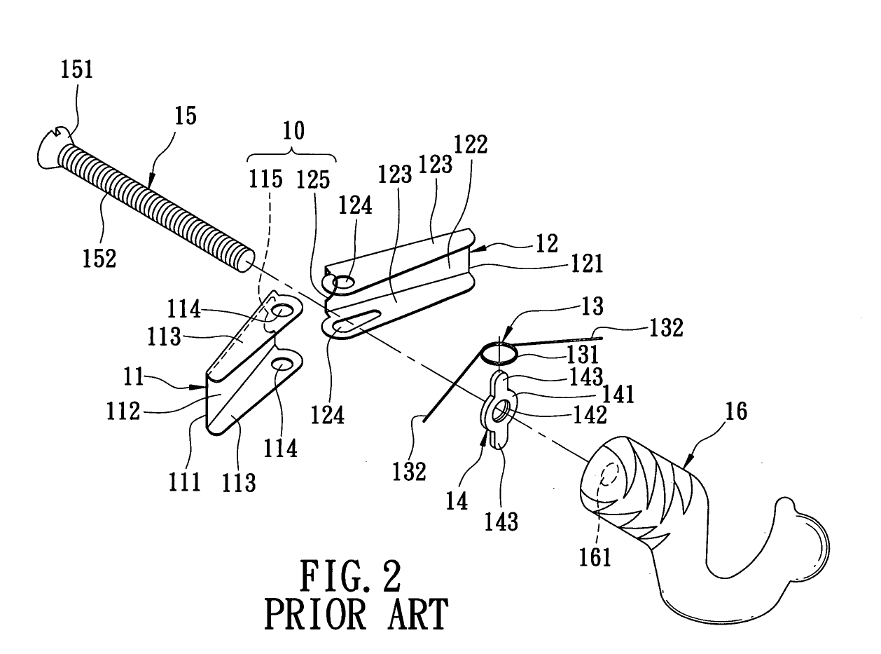

2. Since the nut 4 is received in the through hole 321 in the nut retaining part 32 after assembly, and since the nut retaining part 32, which is thicker and stronger than the nut 14 (see FIG. 2) of the conventional hook retention device 1, serves as a load bearing point, the retention device 100 of the present invention can bear a heavier load. As the retention device 100 is not likely to break when a heavy load is hung on the hook 6, its service life is prolonged.

3. The screw rod 5 is easily turned between the folded position, where it is substantially parallel to the anchor member 3, and the unfolded position, where it is substantially parallel to the anchor member 3, thereby facilitating operation of the retention device 100. Moreover, the size of the passage 71 in the ceiling 7 is only required to be large enough so as to accommodate extension of the nut retaining part 32 therethrough, and need not be enlarged further, thereby enhancing the appearance of the retention device 100 of the present invention.

4. Since less components are used in the present invention, assembly of the retention device 100 is easy. Moreover, after installation, the anchoring surface 34 engages firmly the ceiling 7 so that the retention device 100 is mounted stably on the ceiling 7.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A retention device comprising:
a one-piece longitudinal anchor member having longitudinally opposed first and second ends, a nut retaining part formed between said first and second ends, a through hole extending through said nut retaining part transversely of said anchor member, and an engagement surface around said through hole;
a nut movably received within said through hole; and
a screw rod extending through said through hole and engaging threadedly said nut;
wherein said screw rod is turnable between a folded position in which said screw rod is moved toward said first end, and an unfolded position in which said screw rod is moved away from said first end, and
wherein said nut is movable within said through hole between an engaging position and a non-engaging position, said nut engaging said engagement surface in said engaging position when said screw rod is in said unfolded position, said nut being in said non-engaging position when said screw rod is in said folded position.

2. The retention device as claimed in claim 1, wherein said anchor member includes an anchoring surface extending from said first end to said second end, said nut retaining part protruding outwardly from said anchoring surface in a direction transverse to said anchor member.

3. The retention device as claimed in claim 2, wherein said nut retaining part has a multi-sided lateral wall extending outwardly from said anchoring surface and an end wall connected transversely to said lateral wall, said lateral wall and said end wall confining said through hole, said through hole extending through said end wall.

4. The retention device as claimed in claim 3, wherein said nut retaining part further includes an aperture which is in spatial communication with said throughhole and which extends from said end wall to said lateral wall, said screw rod being turnable along said aperture for movement between said folded and unfolded positions.

5. The retention device as claimed in claim 4, wherein said engagement surface is formed on an inner side of said lateral wall proximate to said end wall.

6. The retention device as claimed in claim 5, wherein said nut has an axially extending peripheral face, and a radial face connected to said peripheral face, said radial face abutting against said end wall and said peripheral face engaging said engagement surface when said nut is in said engaging position.

7. The retention device as claimed in claim 6, wherein said radial face of said nut confronts said lateral wall when said nut is in said non-engaging position.

8. The retention device as claimed in claim 7, wherein said first end of said anchor member is formed with a notch to receive and engage releasably said screw rod when said screw rod is in said folded position.

9. The retention device as claimed in claim 8, wherein said anchor member further includes a resilient element disposed between said nut retaining part and said first end to abut against said screw rod when said screw rod is in said folded position.

10. The retention device as claimed in claim 1, wherein said screw rod is substantially perpendicular to said anchor member in said unfolded position and is substantially parallel to said anchor member in said folded position.

11. The retention device as claimed in claim 2, wherein said anchoring surface is toothed.

12. The retention device as claimed in claim 1, further comprising a hook provided at one end of said screw rod.
